(19) United States
(12) Patent Application Publication
(10) Pub. No.: US 2016/0091913 A1
(43) Pub. Date: Mar. 31, 2016

(54) SMART POWER MANAGEMENT IN SWITCHES AND ROUTERS

(71) Applicant: Cisco Technology, Inc., San Jose, CA (US)

(72) Inventor: Ayaskant Pani, Fremont, CA (US)

(21) Appl. No.: 14/503,066

(22) Filed: Sep. 30, 2014

(51) Int. Cl. G05F 1/66; G06N 5/02

(52) U.S. Cl. CPC G05F 1/66; G06N 5/02

(57) ABSTRACT

Various embodiments of the present disclosure provide methods for analyzing usage information at each of a plurality of network devices of a computing network according to one or more machine learning algorithms and predicting a usage pattern of a corresponding network device at a specific future time. In some embodiments, routing protocol information of a plurality of network devices and one or more corresponding upstream or downstream ports can be collected. Based upon the routing protocol information of the plurality of network devices and the corresponding upstream or downstream ports, or the predicted usage pattern at each of the plurality of network device, a reduced-power-consumption topology that scales with predicted demands at the plurality of network devices can be dynamically generated. An operation state of at least one of the plurality of network devices or at least one corresponding upstream or downstream port can be dynamically adjusted to achieve a power saving at the computing network.

### TECHNICAL FIELD

The present disclosure relates generally to power management in a telecommunications network.

### BACKGROUND

Modern server farms or datacenters typically employ a large number of servers to handle processing need of a variety of application services. Each server, switch, or router requires a certain level of power consumption to maintain operations. The cost of processing power and its associated cooling and delivery can be a significant part of expenditure in operating a large-scale datacenter.

However, datacenters rarely operate in their full capacities. Servers, switches, or routers in a datacenter may consume less power if they can be switched from normal operations to an idle or sleep mode.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 illustrates an example network device in accordance with various implementations;

FIGS. 2A and 2B illustrate example system embodiments in accordance with various implementations of the technology;

FIG. 3 illustrates a schematic block diagram of an example architecture for a network fabric in accordance with various implementations;

FIG. 4 illustrates an example overlay network in accordance with implementations;

FIG. 5 illustrates an example process of achieving a power saving at a plurality of network devices and/or one or more corresponding upstream or downstream ports in accordance with various implementations;

FIG. 6 illustrates an example neural network with auto-encoders in accordance with implementations; and

FIG. 7 illustrates another example process of achieving a power saving at a plurality of network devices and/or one or more corresponding upstream or downstream ports in accordance with various implementations.

### DESCRIPTION OF EXAMPLE EMBODIMENTS

Various implementations of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Systems and methods in accordance with various embodiments of the present disclosure provide a solution to the above-mentioned problems by dynamically shutting down or bringing up ports, switches, or line cards at a computing network based at least upon predicted usage information or routing information of a plurality of network devices at the computing network. More specifically, various embodiments of the present disclosure provide methods for analyzing usage information at each of a plurality of network devices of a computing network according to one or more machine learning algorithms and predicting a usage pattern of a corresponding network device at a specific future time. In some implementations, routing protocol information of a plurality of network devices and one or more corresponding upstream or downstream ports can be collected. Based upon the routing protocol information of the plurality of network devices and upstream or downstream ports, or the predicted usage pattern at each of the plurality of network device, a reduced-power-consumption topology that scales with predicted demands at the plurality of network devices can be dynamically generated. An operation state of at least one of the plurality of network devices (e.g., an access switch) or at least one corresponding upstream or downstream port (e.g., an upstream or downstream ether-channel bundled port) can be dynamically adjusted to achieve a power saving at the computing network. Therefore, power consumption of the computing network can be managed smartly to reduce power consumption costs without compromising performance of the computing network.

In some implementations, historical usage information at a network device is collected within one or more predetermined time windows (e.g., a fixed time period). Apart from the historical usage information, other information associated with the network device can also be gleaned from other sources during the predetermined time windows. The other information includes, but is not limited to, a peer node type identification, time of day, day of a year, port identifier, switch identifier, various interface packet arrival rates, various interface packet drop rates, and packet queue statistics etc. For example, a link layer discovery protocol (LLDP) can be used to identify the type or device type of one or more servers connected to the network device, and information about a virtual machine can be collected from a central management entity (e.g., vCenter). The collected information can serve as an input feature set for the one or more machine learning algorithms to predict a usage pattern at the network device. The one or more machine learning algorithms may include, but are not limited to, at least one of linear regression model, neural network model, support vector machine based model, Bayesian statistics, case-based reasoning, decision trees, inductive logic programming, Gaussian process regression, group method of data handling, learning automata, random forests, ensembles of classifiers, ordinal classification, or conditional random fields.

In some implementations, an operation state of a network device may include a normal operation, low power mode, or shutdown mode. A link connected to a network port can be brought up by initially advertising a high cost metric for the link so that network traffics can avoid the link until network devices associated with the link having their corresponding forward entries programmed. In some implementations, a pre-shutdown process can be executed before a link connected to a network port is brought down.

### Description

A computer network is a geographically distributed collection of nodes interconnected by communication links and segments for transporting data between endpoints, such as personal computers and workstations. Many types of networks are available, with the types ranging from local area networks (LANs) and wide area networks (WANs) to overlay and software-defined networks, such as virtual extensible local area networks (VXLANs).

LANs typically connect nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. LANs and WANs can include layer 2 (L2) and/or layer 3 (L3) networks and devices.

The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks may be further interconnected by an intermediate network node, such as a router, to extend the effective “size” of each network.

Overlay networks generally allow virtual networks to be created and layered over a physical network infrastructure. Overlay network protocols, such as Virtual Extensible LAN (VXLAN), Network Virtualization using Generic Routing Encapsulation (NVGRE), Network Virtualization Overlays (NVO3), and Stateless Transport Tunneling (STT), provide a traffic encapsulation scheme which allows network traffic to be carried across L2 and L3 networks over a logical tunnel. Such logical tunnels can be originated and terminated through virtual tunnel end points (VTEPs).

Moreover, overlay networks can include virtual segments, such as VXLAN segments in a VXLAN overlay network, which can include virtual L2 and/or L3 overlay networks over which VMs communicate. The virtual segments can be identified through a virtual network identifier (VNI), such as a VXLAN network identifier, which can specifically identify an associated virtual segment or domain.

Network virtualization allows hardware and software resources to be combined in a virtual network. For example, network virtualization can allow multiple numbers of VMs to be attached to the physical network via respective virtual LANs (VLANs). The VMs can be grouped according to their respective VLAN, and can communicate with other VMs as well as other devices on the internal or external network.

Network segments, such as physical or virtual segments, networks, devices, ports, physical or logical links, and/or traffic in general can be grouped into a bridge or flood domain. A bridge domain or flood domain can represent a broadcast domain, such as an L2 broadcast domain. A bridge domain or flood domain can include a single subnet, but can also include multiple subnets. Moreover, a bridge domain can be associated with a bridge domain interface on a network device, such as a switch. A bridge domain interface can be a logical interface which supports traffic between an L2 bridged network and an L3 routed network. In addition, a bridge domain interface can support internet protocol (IP) termination, VPN termination, address resolution handling, MAC addressing, etc. Both bridge domains and bridge domain interfaces can be identified by a same index or identifier.

Furthermore, endpoint groups (EPGs) can be used in a network for mapping applications to the network. In particular, EPGs can use a grouping of application endpoints in a network to apply connectivity and policy to the group of applications. EPGs can act as a container for buckets or collections of applications, or application components, and tiers for implementing forwarding and policy logic. EPGs also allow separation of network policy, security, and forwarding from addressing by instead using logical application boundaries.

Cloud computing can also be provided in one or more networks to provide computing services using shared resources. Cloud computing can generally include Internet-based computing in which computing resources are dynamically provisioned and allocated to client or user computers or other devices on-demand, from a collection of resources available via the network (e.g., “the cloud”). Cloud computing resources, for example, can include any type of resource, such as computing, storage, and network devices, virtual machines (VMs), etc. For instance, resources may include service devices (firewalls, deep packet inspectors, traffic monitors, load balancers, etc.), compute/processing devices (servers, CPU's, memory, brute force processing capability), storage devices (e.g., network attached storages, storage area network devices), etc. In addition, such resources may be used to support virtual networks, virtual machines (VM), databases, applications (Apps), etc.

Cloud computing resources may include a “private cloud,” a “public cloud,” and/or a “hybrid cloud.” A “hybrid cloud” can be a cloud infrastructure composed of two or more clouds that inter-operate or federate through technology. In essence, a hybrid cloud is an interaction between private and public clouds where a private cloud joins a public cloud and utilizes public cloud resources in a secure and scalable manner. Cloud computing resources can also be provisioned via virtual networks in an overlay network, such as a VXLAN.

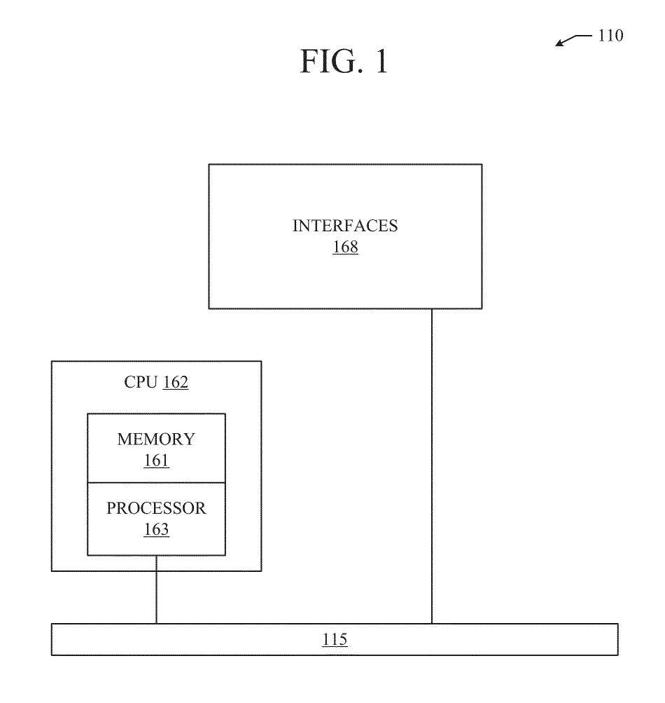

In a modular switch, the number of forwarding entries can be scaled by spreading or “sharding” addresses across multiple switch devices. Each of the multiple switch devices holds part of a lookup table. However, it remains a challenge to determine a switch device that a particular address resides on at the time of programming the lookup table and/or when doing lookups at line rate. Quite often, the addresses in the lookup table are not evenly spread across the multiple switch devices. As a result, many active addresses are mapped to a small set of switch devices, which lead to hotspot issues. Therefore, an improved “sharding” or spreading algorithm is desired to evenly and randomly shard or spread addresses across multiple switch devices. The disclosed technology addresses the need in the art for sharding address lookups in a telecommunications network. Disclosed are systems, methods, and computer-readable storage media for randomly and evenly mapping entries in a lookup/forwarding table across multiple switch devices. A brief introductory description of example systems and networks, as illustrated in FIGS. 1 through 4, is disclosed herein. A detailed description of an example process for generating a forwarding table and randomly and evenly mapping entries in the forwarding table across multiple switch devices, related concepts, and example variations, will then follow. These variations shall be described herein as the various embodiments are set forth. The disclosure now turns to FIG. 1.

FIG. 1 illustrates an example network device 110 suitable for implementing the present invention. Network device 110 includes a master central processing unit (CPU) 162, interfaces 168, and a bus 115 (e.g., a PCI bus). When acting under the control of appropriate software or firmware, the CPU 162 is responsible for executing packet management, error detection, and/or routing functions, such as miscabling detection functions, for example. The CPU 162 preferably accomplishes all these functions under the control of software including an operating system and any appropriate applications software. CPU 162 may include one or more processors 163 such as a processor from the Motorola family of microprocessors or the MIPS family of microprocessors. In an alternative embodiment, processor 163 is specially designed hardware for controlling the operations of router 110. In a specific embodiment, a memory 161 (such as non-volatile RAM and/or ROM) also forms part of CPU 162. However, there are many different ways in which memory could be coupled to the system.

The interfaces 168 are typically provided as interface cards (sometimes referred to as “line cards”). Generally, they control the sending and receiving of data packets over the network and sometimes support other peripherals used with the router 110. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 162 to efficiently perform routing computations, network diagnostics, security functions, etc.

Although the system shown in FIG. 1 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Various types of electronic or computing devices that are capable of receiving and forwarding network packets may also be included. The computing device may use operating systems that include, but are not limited to, Android, Berkeley Software Distribution (BSD), iPhone OS (iOS), Linus, OS X, Unix-like Real-time Operating System (e.g., QNX), Microsoft Windows, Window Phone, and IBM z/OS.

Regardless of the network device's configuration, it may employ one or more memories or memory modules (including memory 161) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

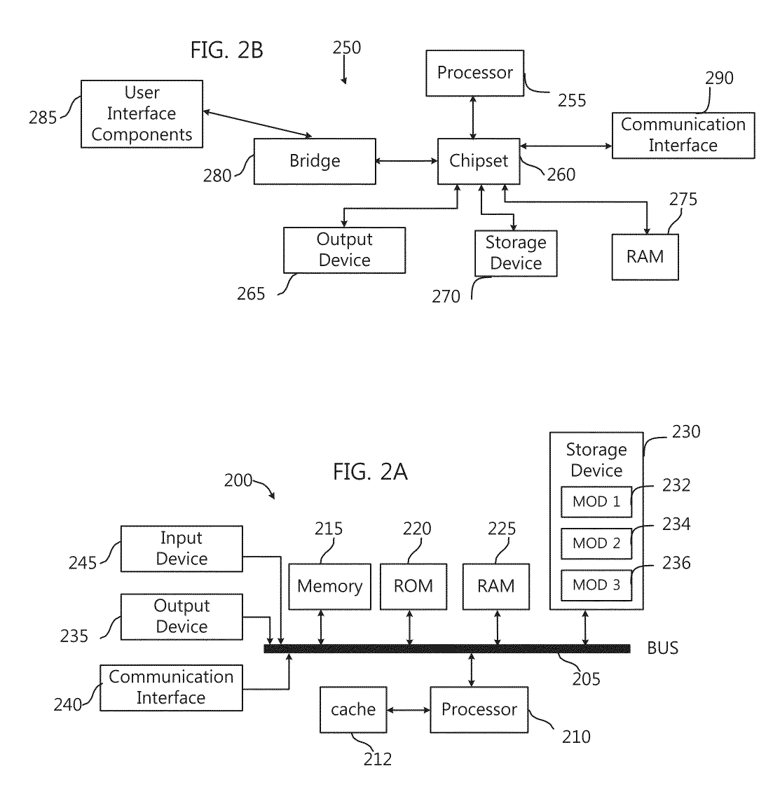

FIG. 2A, and FIG. 2B illustrate example possible system embodiments. The more appropriate embodiment will be apparent to those of ordinary skill in the art when practicing the present technology. Persons of ordinary skill in the art will also readily appreciate that other system embodiments are possible.

FIG. 2A illustrates a conventional system bus computing system architecture 200 wherein the components of the system are in electrical communication with each other using a bus 205. Example system 200 includes a processing unit (CPU or processor) 210 and a system bus 205 that couples various system components including the system memory 215, such as read only memory (ROM) 220 and random access memory (RAM) 225, to the processor 210. The system 200 can include a cache of high-speed memory connected directly with, in close proximity to, or integrated as part of the processor 210. The system 200 can copy data from the memory 215 and/or the storage device 230 to the cache 212 for quick access by the processor 210. In this way, the cache can provide a performance boost that avoids processor 210 delays while waiting for data. These and other modules can control or be configured to control the processor 210 to perform various actions. Other system memory 215 may be available for use as well. The memory 215 can include multiple different types of memory with different performance characteristics. The processor 210 can include any general purpose processor and a hardware module or software module, such as module 1 232, module 2 234, and module 3 236 stored in storage device 230, configured to control the processor 210 as well as a special-purpose processor where software instructions are incorporated into the actual processor design. The processor 210 may essentially be a completely self-contained computing system, containing multiple cores or processors, a bus, memory controller, cache, etc. A multi-core processor may be symmetric or asymmetric.

To enable user interaction with the computing device 200, an input device 245 can represent any number of input mechanisms, such as a microphone for speech, a touch-sensitive screen for gesture or graphical input, keyboard, mouse, motion input, speech and so forth. An output device 235 can also be one or more of a number of output mechanisms known to those of skill in the art. In some instances, multimodal systems can enable a user to provide multiple types of input to communicate with the computing device 200. The communications interface 240 can generally govern and manage the user input and system output. There is no restriction on operating on any particular hardware arrangement and therefore the basic features here may easily be substituted for improved hardware or firmware arrangements as they are developed.

Storage device 230 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 225, read only memory (ROM) 220, and hybrids thereof.

The storage device 230 can include software modules 232, 234, 236 for controlling the processor 210. Other hardware or software modules are contemplated. The storage device 230 can be connected to the system bus 205. In one aspect, a hardware module that performs a particular function can include the software component stored in a computer-readable medium in connection with the necessary hardware components, such as the processor 210, bus 205, output device 235 (e.g., a display), and so forth, to carry out the function.

FIG. 2B illustrates a computer system 250 having a chipset architecture that can be used in executing the described method and generating and displaying a graphical user interface (GUI). Computer system 250 is an example of computer hardware, software, and firmware that can be used to implement the disclosed technology. System 250 can include a processor 255, representative of any number of physically and/or logically distinct resources capable of executing software, firmware, and hardware configured to perform identified computations. Processor 255 can communicate with a chipset 260 that can control input to and output from processor 255. In this example, chipset 260 outputs information to output 265, such as a display, and can read and write information to storage device 270, which can include magnetic media, and solid state media, for example. Chipset 260 can also read data from and write data to RAM 275. A bridge 280 for interfacing with a variety of user interface components 285 can be provided for interfacing with chipset 260. Such user interface components 285 can include a keyboard, a microphone, touch detection and processing circuitry, a pointing device, such as a mouse, and so on. In general, inputs to system 250 can come from any of a variety of sources, machine generated and/or human generated.

Chipset 260 can also interface with one or more communication interfaces 290 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 255 analyzing data stored in storage 270 or RAM 275. Further, the machine can receive inputs from a user via user interface components 285 and execute appropriate functions, such as browsing functions by interpreting these inputs using processor 255.

It can be appreciated that example systems 200 and 250 can have more than one processor 210 or be part of a group or cluster of computing devices networked together to provide greater processing capability.

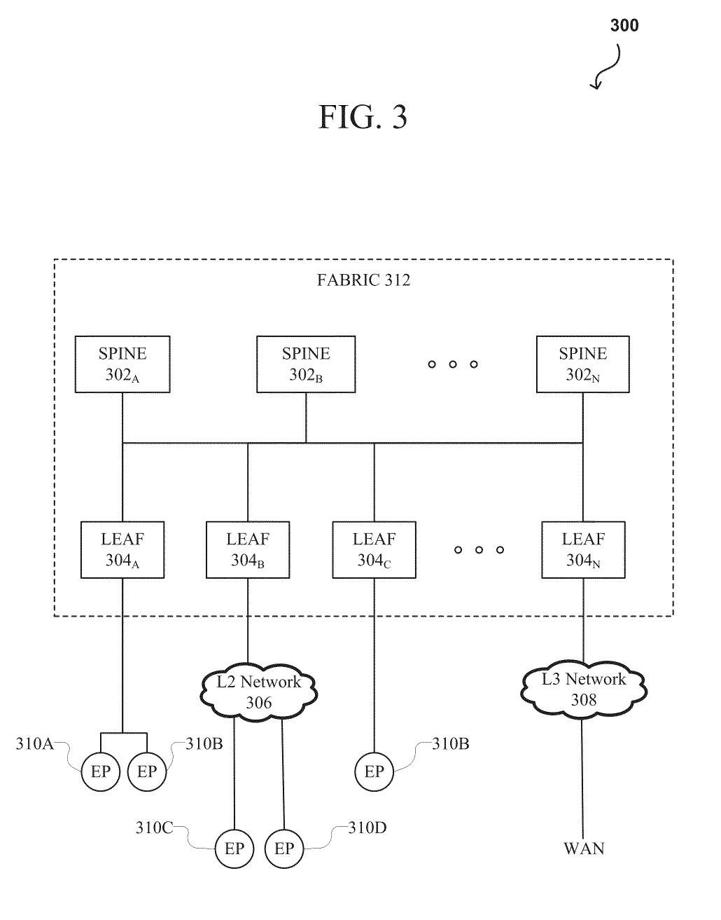

FIG. 3 illustrates a schematic block diagram of an example architecture 300 for a network fabric 312. The network fabric 312 can include spine switches 302_{A}, 302_{B}, . . . , 302_{N} (collectively “302”) connected to leaf switches 304_{A}, 304_{B}, 304_{C}, . . . , 304_{N} (collectively “304”) in the network fabric 312.

Spine switches 302 can be L3 switches in the fabric 312. However, in some cases, the spine switches 302 can also, or otherwise, perform L2 functionalities. Further, the spine switches 302 can support various capabilities, such as 40 or 10 Gbps Ethernet speeds. To this end, the spine switches 302 can include one or more 40 Gigabit Ethernet ports. Each port can also be split to support other speeds. For example, a 40 Gigabit Ethernet port can be split into four 10 Gigabit Ethernet ports.

In some embodiments, one or more of the spine switches 302 can be configured to host a proxy function that performs a lookup of the endpoint address identifier to locator mapping in a mapping database on behalf of leaf switches 304 that do not have such mapping. The proxy function can do this by parsing through the packet to the encapsulated, tenant packet to get to the destination locator address of the tenant. The spine switches 302 can then perform a lookup of their local mapping database to determine the correct locator address of the packet and forward the packet to the locator address without changing certain fields in the header of the packet.

When a packet is received at a spine switch 302ᵢ, the spine switch 302ᵢ can first check if the destination locator address is a proxy address. If so, the spine switch 302ᵢ can perform the proxy function as previously mentioned. If not, the spine switch 302ᵢ can lookup the locator in its forwarding table and forward the packet accordingly.

Spine switches 302 connect to leaf switches 304 in the fabric 312. Leaf switches 304 can include access ports (or non-fabric ports) and fabric ports. Fabric ports can provide uplinks to the spine switches 302, while access ports can provide connectivity for devices, hosts, endpoints, VMs, or external networks to the fabric 312.

Leaf switches 304 can reside at the edge of the fabric 312, and can thus represent the physical network edge. In some cases, the leaf switches 304 can be top-of-rack (“ToR”) switches configured according to a ToR architecture. In other cases, the leaf switches 304 can be aggregation switches in any particular topology, such as end-of-row (EoR) or middle-of-row (MoR) topologies. The leaf switches 304 can also represent aggregation switches, for example.

The leaf switches 304 can be responsible for routing and/or bridging the tenant packets and applying network policies. In some cases, a leaf switch can perform one or more additional functions, such as implementing a mapping cache, sending packets to the proxy function when there is a miss in the cache, encapsulate packets, enforce ingress or egress policies, etc.

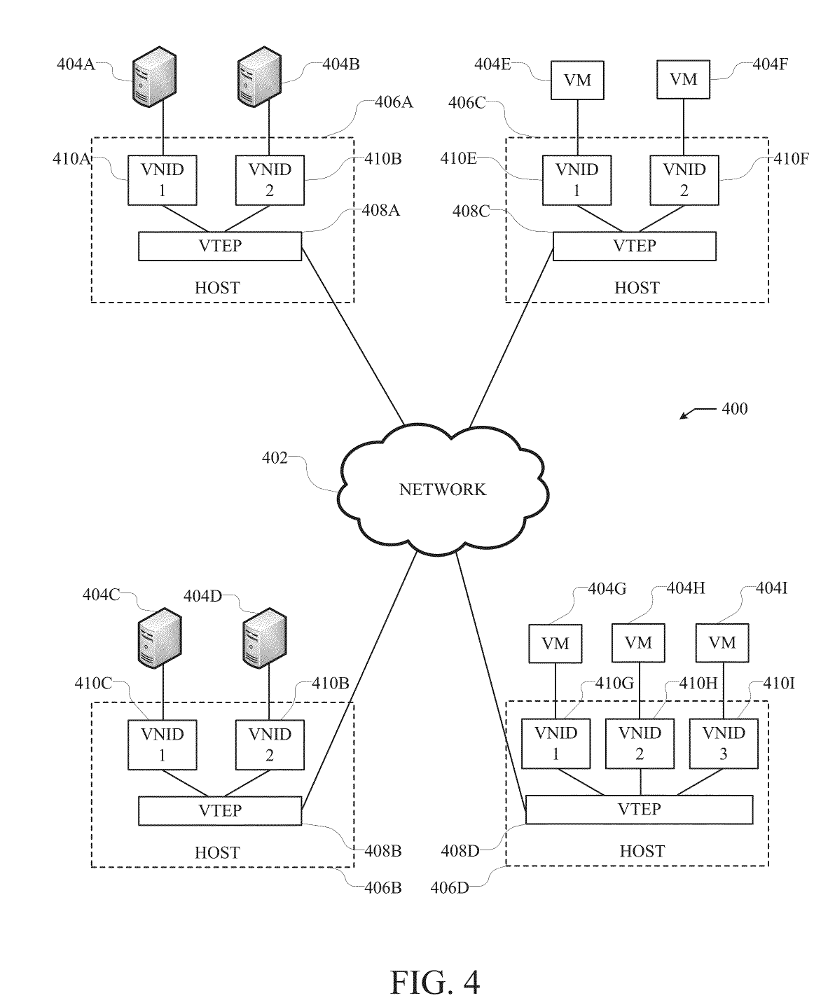

Moreover, the leaf switches 304 can contain virtual switching functionalities, such as a virtual tunnel endpoint (VTEP) function as explained below in the discussion of VTEP 408 in FIG. 4. To this end, leaf switches 304 can connect the fabric 312 to an overlay network, such as overlay network 400 illustrated in FIG. 4.

Network connectivity in the fabric 312 can flow through the leaf switches 304. Here, the leaf switches 304 can provide servers, resources, endpoints, external networks, or VMs access to the fabric 312, and can connect the leaf switches 304 to each other. In some cases, the leaf switches 304 can connect EPGs to the fabric 312 and/or any external networks. Each EPG can connect to the fabric 312 via one of the leaf switches 304, for example.

Endpoints 310A-E (collectively “310”) can connect to the fabric 312 via leaf switches 304. For example, endpoints 310A and 310B can connect directly to leaf switch 304A, which can connect endpoints 310A and 310B to the fabric 312 and/or any other one of the leaf switches 304. Similarly, endpoint 310E can connect directly to leaf switch 304C, which can connect endpoint 310E to the fabric 312 and/or any other of the leaf switches 304. On the other hand, endpoints 310C and 310D can connect to leaf switch 304B via L2 network 306. Similarly, the wide area network (WAN) can connect to the leaf switches 304C or 304D via L3 network 308.

Endpoints 310 can include any communication device, such as a computer, a server, a switch, a router, etc. In some cases, the endpoints 310 can include a server, hypervisor, or switch configured with a VTEP functionality which connects an overlay network, such as overlay network 400 below, with the fabric 312. For example, in some cases, the endpoints 310 can represent one or more of the VTEPs 408A-D illustrated in FIG. 4. Here, the VTEPs 408A-D can connect to the fabric 312 via the leaf switches 304. The overlay network can host physical devices, such as servers, applications, EPGs, virtual segments, virtual workloads, etc. In addition, the endpoints 310 can host virtual workload(s), clusters, and applications or services, which can connect with the fabric 312 or any other device or network, including an external network. For example, one or more endpoints 310 can host, or connect to, a cluster of load balancers or an EPG of various applications.

Although the fabric 312 is illustrated and described herein as an example leaf-spine architecture, one of ordinary skill in the art will readily recognize that the subject technology can be implemented based on any network fabric, including any data center or cloud network fabric. Indeed, other architectures, designs, infrastructures, and variations are contemplated herein.

FIG. 4 illustrates an example overlay network 400. Overlay network 400 uses an overlay protocol, such as VXLAN, VGRE, VO3, or STT, to encapsulate traffic in L2 and/or L3 packets which can cross overlay L3 boundaries in the network. As illustrated in FIG. 4, overlay network 400 can include hosts 406A-D interconnected via network 402.

Network 402 can include a packet network, such as an IP network, for example. Moreover, network 402 can connect the overlay network 400 with the fabric 312 in FIG. 3. For example, VTEPs 408A-D can connect with the leaf switches 304 in the fabric 312 via network 402.

Hosts 406A-D include virtual tunnel end points (VTEP) 408A-D, which can be virtual nodes or switches configured to encapsulate and de-encapsulate data traffic according to a specific overlay protocol of the network 400, for the various virtual network identifiers (VNIDs) 410A-I. Moreover, hosts 406A-D can include servers containing a VTEP functionality, hypervisors, and physical switches, such as L3 switches, configured with a VTEP functionality. For example, hosts 406A and 406B can be physical switches configured to run VTEPs 408A-B. Here, hosts 406A and 406B can be connected to servers 404A-D, which, in some cases, can include virtual workloads through VMs loaded on the servers, for example.

In some embodiments, network 400 can be a VXLAN network, and VTEPs 408A-D can be VXLAN tunnel end points. However, as one of ordinary skill in the art will readily recognize, network 400 can represent any type of overlay or software-defined network, such as NVGRE, STT, or even overlay technologies yet to be invented.

The VNIDs can represent the segregated virtual networks in overlay network 400. Each of the overlay tunnels (VTEPs 408A-D) can include one or more VNIDs. For example, VTEP 408A can include VNIDs 1 and 2, VTEP 408B can include VNIDs 1 and 3, VTEP 408C can include VNIDs 1 and 2, and VTEP 408D can include VNIDs 1-3. As one of ordinary skill in the art will readily recognize, any particular VTEP can, in other embodiments, have numerous VNIDs, including more than the 3 VNIDs illustrated in FIG. 4.

The traffic in overlay network 400 can be segregated logically according to specific VNIDs. This way, traffic intended for VNID 1 can be accessed by devices residing in VNID 1, while other devices residing in other VNIDs (e.g., VNIDs 2 and 3) can be prevented from accessing such traffic. In other words, devices or endpoints connected to specific VNIDs can communicate with other devices or endpoints connected to the same specific VNIDs, while traffic from separate VNIDs can be isolated to prevent devices or endpoints in other specific VNIDs from accessing traffic in different VNIDs.

Servers 404A-D and VMs 404E-I can connect to their respective VNID or virtual segment, and communicate with other servers or VMs residing in the same VNID or virtual segment. For example, server 404A can communicate with server 404C and VMs 404E and 404G because they all reside in the same VNID, viz., VNID 1. Similarly, server 404B can communicate with VMs 404F, H because they all reside in VNID 2. VMs 404E-I can host virtual workloads, which can include application workloads, resources, and services, for example. However, in some cases, servers 404A-D can similarly host virtual workloads through VMs hosted on the servers 404A-D. Moreover, each of the servers 404A-D and VMs 404E-I can represent a single server or VM, but can also represent multiple servers or VMs, such as a cluster of servers or VMs.

VTEPs 408A-D can encapsulate packets directed at the various VNIDs 1-3 in the overlay network 400 according to the specific overlay protocol implemented, such as VXLAN, so traffic can be properly transmitted to the correct VNID and recipient(s). Moreover, when a switch, router, or other network device receives a packet to be transmitted to a recipient in the overlay network 400, it can analyze a routing table, such as a lookup table, to determine where such packet needs to be transmitted so the traffic reaches the appropriate recipient. For example, if VTEP 408A receives a packet from endpoint 404B that is intended for endpoint 404H, VTEP 408A can analyze a routing table that maps the intended endpoint, endpoint 404H, to a specific switch that is configured to handle communications intended for endpoint 404H. VTEP 408A might not initially know, when it receives the packet from endpoint 404B, that such packet should be transmitted to VTEP 408D in order to reach endpoint 404H. Accordingly, by analyzing the routing table, VTEP 408A can lookup endpoint 404H, which is the intended recipient, and determine that the packet should be transmitted to VTEP 408D, as specified in the routing table based on endpoint-to-switch mappings or bindings, so the packet can be transmitted to, and received by, endpoint 404H as expected.

However, continuing with the previous example, in many instances, VTEP 408A may analyze the routing table and fail to find any bindings or mappings associated with the intended recipient, e.g., endpoint 404H. Here, the routing table may not yet have learned routing information regarding endpoint 404H. In this scenario, the VTEP 408A may likely broadcast or multicast the packet to ensure the proper switch associated with endpoint 404H can receive the packet and further route it to endpoint 404H.

In some cases, the routing table can be dynamically and continuously modified by removing unnecessary or stale entries and adding new or necessary entries, in order to maintain the routing table up-to-date, accurate, and efficient, while reducing or limiting the size of the table.

As one of ordinary skill in the art will readily recognize, the examples and technologies provided above are simply for clarity and explanation purposes, and can include many additional concepts and variations.

Depending on the desired implementation in the network 400, a variety of networking and messaging protocols may be used, including but not limited to TCP/IP, open systems interconnection (OSI), file transfer protocol (FTP), universal plug and play (UpnP), network file system (NFS), common internet file system (CIFS), AppleTalk etc. As would be appreciated by those skilled in the art, the network 400 illustrated in FIG. 4 is used for purposes of explanation, a network system may be implemented with many variations, as appropriate, in the configuration of network platform in accordance with various embodiments of the present disclosure.

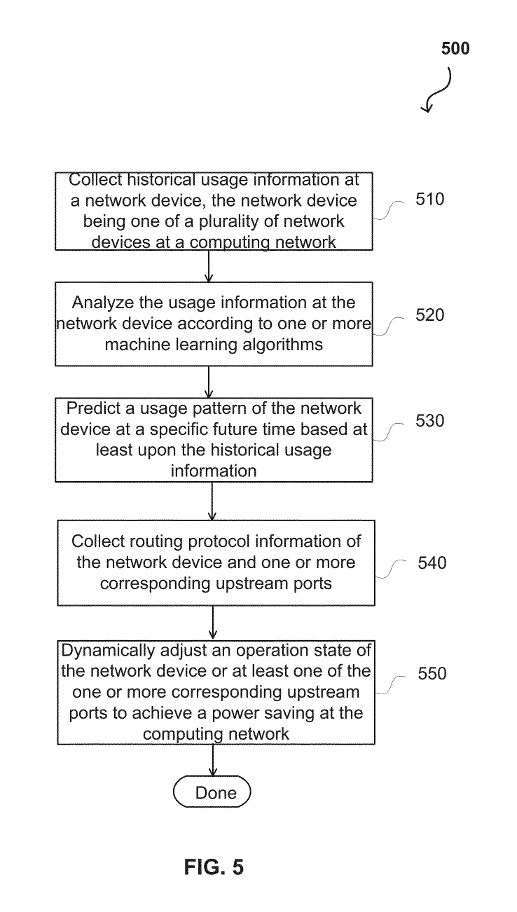

Having disclosed some basic system components and concepts, the disclosure now turns to the example method shown in FIG. 5. For the sake of clarity, the method is described in terms of systems 110, 200, 250, 300, and 400, as shown in FIGS. 1-4, configured to practice the method. The steps outlined herein are example and can be implemented in any combination thereof, including combinations that exclude, add, or modify certain steps.

FIG. 5 illustrates an example process 500 of achieving a power saving at a plurality of network devices and/or one or more corresponding upstream or downstream ports in accordance with various implementations. It should be understood that there can be additional, fewer, or alternative steps performed in similar or alternative orders, or in parallel, within the scope of the various embodiments unless otherwise stated. The example method embodiment 500 starts with collecting historical usage information at a network device, at step 510. The network device can be one of a plurality of network devices at a computing network and may be any device capable of receiving or transmitting a packet at a computing network, such as an intermediate network node (e.g., a router) and a switch. In some implementations, historical usage information at a network device is collected within one or more predetermined time windows (e.g., a fixed time period, such as 5 minutes).

The historical usage information collected at the network device can be analyzed according to one or more machine learning algorithms, at step 520. The one or more machine learning algorithms may include, but are not limited to, at least one of linear regression model, neural network model, support vector machine based model, Bayesian statistics, case-based reasoning, decision trees, inductive logic programming, Gaussian process regression, group method of data handling, learning automata, random forests, ensembles of classifiers, ordinal classification, or conditional random fields. At step 530, a usage pattern at the network device can be predicted based at least upon the historical usage information at the network device.

For example, the historical usage information can be analyzed by using a linear regression model according a Gradient descent algorithm or a support vector machine model according to a linear kernel algorithm. The algorithm can be used to run on a sampled instance of an entire feature variable set and adjust a linear regression parameter (e.g., Theta vector also known as weight parameters of a machine learning model) to minimize an error function of the linear regression model. At the beginning, an error rate may be high due to lacking of historical data points. Some implementations may require a minimum number of historical instances be collected and analyzed before predict a usage pattern at a network device.

In some implementations, collected usage information from other network devices may be collected and stored in a database. A newly deployed network device can analyze the stored usage information to predict an initial usage pattern at the network device by using a batch-gradient descent algorithm. When the initial usage pattern is predicted, some embodiments analyze historical usage information collected on the network device by using a stochastic model. In some embodiments, an updated Theta vector can be stored in a storage such that a network switch can recover from a reboot and use a stored Theta vector value to make prediction rather than relearn everything from a scratch. In some other implementations, a support vector machine model can be used together with a linear kernel to train a machine learning model to analyze collected usage information at a network device. Exemplary pseudocode for predicting a usage pattern at a network device using a linear regressions model is provided below.

Upon a reboot of a network switch, read saved linear regression model
parameters (e.g, Theta Vector) if saved, else initialize to 0.
After every time-window do {
Calculate New Theta[j] where Theta[j] is the jth parameter
including the intercept parameter.
For J−1 to N do {
Theta[j] = Theta[j] − {(Alpha*(Prediction(X)-Observed_Traffic)*X[j])}
}
Where
Prediction is the linear regression over Theta and given feature
var set (X) (i.e., Prediction(X)=Sum(Theta[j]*X[j]) for j=1 to n);
And Alpha is the learning parameter with a range of 0.01 to 0.5.

In the above exemplary pseudocode, X is feature vectors with a total number of feature variable, N. An intercept feature variable X[0] is set to 1. Observed_{—} Traffic is an observed traffic at the network device. In some implementations, regularization can be used to address over-fitting of Theta parameters.

For another example, a neural network model or support vector machine regression model may also be used to analyze historical usage information and capture complex correlation between time and traffic pattern at a particular network device. In some embodiments, a neural network model can have two or more hidden layers with suitable units (e.g., 20 to 30) to capture a complex correlation among a set of feature variables. In some embodiments, deep neural networks are stacked auto-encoders or Restricted-Boltzmann Machines (RBMs) that can be trained using a back-propagation algorithm with regularization. Expected traffic at a particular network device can be a target function with the set of feature variables.

Various neural network models can be used together with one or more forward and backward propagation algorithms to reduce a cost function at a particular network device. The cost function is a squared error sum of differences between predicted and actual traffic of all sample points at a particular network device.

In some implementations, a neural network model can be used to run a batch model. A network controller (e.g., Insieme network controller (IFC)) may be used to run a neural network model together with a back propagation algorithm to analyze a sampled set collected from a plurality of network devices. A machine-learned neural network model can then be fed back to each of the plurality of network devices.

In some implementations, a neural network model can be used to run a mini-batch model. Each of a plurality of network devices can collect a set of samples and run a neural network model to machine-learn a parameter vector (Theta) of each neural network nodes. In response to a new set of samples being collected, the neural network model can be used to process the new set of samples to readjust and refine a parameter vector of the neural network model.

At step 540, routing protocol information of the network device and one or more corresponding upstream or downstream ports can be collected. An operation state of the one or more corresponding upstream or downstream ports (e.g., an upstream or downstream ether-channel bundled port) or the network device (e.g., an access switch) can be dynamically adjusted to achieve a power saving at the computing network, at step 550. An Ether-channel may allow grouping of several physical Ethernet links to created one logical Ethernet link for the purpose of providing fault-tolerance and high-speed links between network devices (e.g., switches, routers and servers). For example, an Ether-Channel can be created from between two and eight active Gigabit or 10-Gigabit Ethernet ports, with an additional one to eight inactive (failover) ports that can become active when any active port fails.

In some implementations, at least one of a plurality of criteria may be used in determining whether to bringing up or shut down any of the plurality of network devices or their corresponding upstream or downstream ports, application specific integrated circuits (ASICs), or line cards. The plurality of criteria may include a predetermined buffer for unexpected increases of future traffic rate (e.g., a buffer with a value 25% above a predicted traffic rate), or two or more redundant links to other network devices for each of the plurality of network devices. In some embodiments, one upstream or downstream port of a network device (e.g., a port in a fabric card) can be selectively shut down to see whether there is still a fully connected graph (i.e., a transitive closure of a network remains connected even without the upstream or downstream port). In some implementations, one or more high bias feature variables can be used to adapt to sudden demand changes by using a packet drop counter of an interface to indicate that an excessive demand has occurred.

In some implementations, a link connected to a port can be brought up by initially advertising a high cost metric for the link so that network traffics can avoid the link until network devices (e.g., network switches) associated with the link having their corresponding forwarding entries programmed. In response to the network devices associated with the link having their forwarding entries programmed, a regular cost metric can be advertised for the link such that the networking capacity of a computing network can be gradually increased without risking potential connection drops.

In some implementations, a link connected to a port can be shut down after going through a pre-shutdown process. The pre-shutdown process may include increasing the cost of the link without removing programmed forwarding entries at network devices (e.g., network switches) that are associated with the link. After a predetermined period of delay, the link can be shut down. In some embodiments, the predetermined period of delay is a suitable period of time such that network devices connected with the link can steer away traffics from the link to minimize possible connection drops while the link is brought down.

In some implementations, at least one of one or more upstream or downstream ports or at least one of a plurality of network devices can be dynamically switched to a low speed mode to save operation power of a computing network. For example, a port can be dynamically switched to a 1G mode instead of running at a regular 40G speed.

In an n-way virtual port channel (VPC), an Ethernet switch is connected to n switches such that the n switches appear as a single switch to the Ethernet switch. The VPC may allow the Ethernet switch to have two or more links to each of the n switches such that the two or more links appear as one link. Some embodiments can decide how many ports to keep in an operation mode, shut-down mode, or low power mode, based at least upon usage demand of the n-way VPC.

Some algorithms may further analyze usage demand of a plurality of network devices and their respective upstream or downstream ports as a whole. Two or more collocated ports, ASICs, or Line Cards may be shut down or switched to a low power mode together such that additional power saving can be achieved.

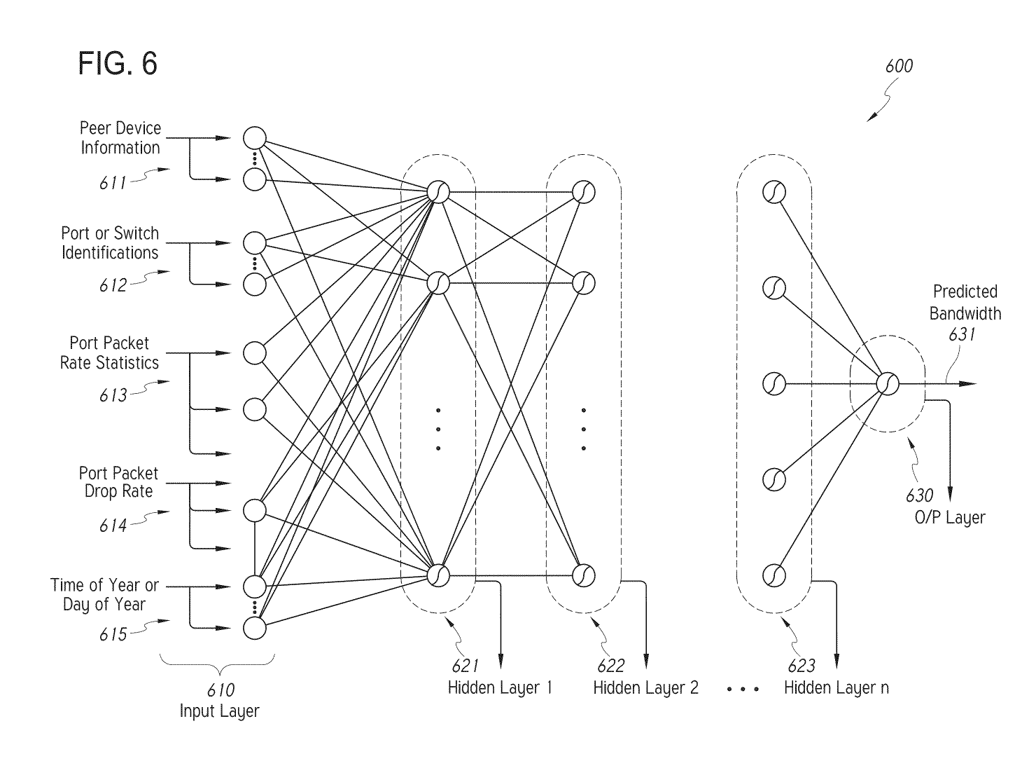

FIG. 6 illustrates an example neural network 600 with auto-encoders in accordance with implementations. The neural network 600 includes an input layer 610 to receive a plurality of inputs, one or more hidden layers (e.g., hidden layer 1 621, hidden layer 2 622, and hidden layer n 623), and an output layer 630 to generate an output 631. The neural network 600 is capable of approximating non-linear functions of the plurality of inputs related to a network device and generating a predicted bandwidth 631 for the network device. The plurality of inputs related to the network device may include, but are not limited to, peer device information (e.g., identifications and types) 611, port or switch identifications 612, port packet rate statistics 613, port packet drop rate 614, and time of year or day of year 615.

In some implementations, each node of the one or more hidden layers may take input data, perform an operation on the data, and selectively pass results to other nodes of the one or more hidden layers. The output of each node is called its activation. Weight values associated with each node constrain how input data are related to output data of the corresponding node. Weight values of each node can be determined by iterative flows of training data through the neural network 600. For example, activations of the one more hidden layers may be generated using a sigmoid function and an activation of the output layer 630 may be generated by using a linear function (i.e., a perceptron output). Once trained, the neural network 600 can be used to generate the predicted bandwidth 631 for the network device.

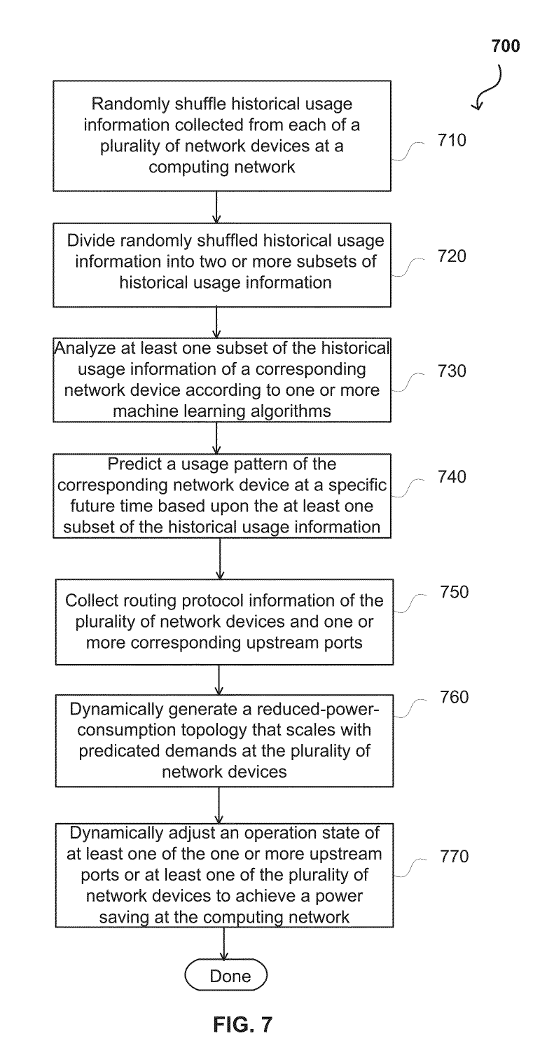

FIG. 7 illustrates another example process 700 of achieving a power saving at a plurality of network devices and/or one or more corresponding upstream or downstream ports in accordance with various implementations. The example method embodiment 700 starts with randomly shuffling historical usage information collected from each of a plurality of network devices at a computing network, at step 710. Each of the plurality of network devices may be a device capable of receiving or transmitting a packet at the computing network, such as an intermediate network node (e.g., a router) and a switch. Shuffled historical usage information can be divided into two or more subsets of historical usage information, at step 720. Each subset of historical usage information may represent usage information at a corresponding network device and can be used as a training set for one or more machine learning algorithms. At step 730, at least one subset of the historical usage information at the corresponding network device can be analyzed according to the one or more machine learning algorithms. In some embodiments, multiple passes can be made over the at least one subset of the historical usage information until the one or more machine learning algorithms converge. In some embodiments, historical usage information at the corresponding network device can be reshuffled for each pass to prevent cycles.

At step 740, a usage pattern of the network device at a specific future time can be predicted based at least upon the at least one subset of the historical usage information. In some embodiments, predicted usage pattern can be periodically compared with actual usage pattern at the corresponding network device to continuously train the one or more machine learning algorithms.

At step 750, routing protocol information of the plurality of network devices and one or more corresponding upstream or downstream ports can be collected. Based upon the routing protocol information of the plurality of network devices and the corresponding one or more upstream or downstream ports, or the predicted usage pattern at each of the plurality of network device, a reduced-power-consumption topology that scales with predicted demands at the plurality of network devices can be dynamically generated, at step 760. In some implementations, a suitable redundancy can be built together with the reduced-power-consumption topology to handle unanticipated network disruptions (e.g., link or node failures). An operation state of at least one of the one or more upstream or downstream ports (e.g., an upstream or downstream ether-channel bundled port) or at least one of the plurality of network devices (e.g., an access switch) can be dynamically adjusted to achieve a power saving at the computing network, at step 770.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

In some implementations, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Various embodiments of the present disclosure provide methods for analyzing usage information at each of a plurality of network devices at a computing network according to one or more machine learning algorithms in order to achieve a power saving at the computing network. While specific examples have been cited above showing how the optional operation may be employed in different instructions, other embodiments may incorporate the optional operation into different instructions. For clarity of explanation, in some instances the present disclosure may be presented as including individual functional blocks including functional blocks comprising devices, device components, steps or routines in a method embodied in software, or combinations of hardware and software.

The various embodiments can be further implemented in a wide variety of operating environments, which in some cases can include one or more server computers, user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

To the extent embodiments, or portions thereof, are implemented in hardware, the present invention may be implemented with any or a combination of the following technologies: a discrete logic circuit(s) having logic gates for implementing logic functions upon data signals, an application specific integrated circuit (ASIC) having appropriate combinational logic gates, programmable hardware such as a programmable gate array(s) (PGA), a field programmable gate array (FPGA), etc.

Most implementations utilize at least one network that would be familiar to those skilled in the art for supporting communications using any of a variety of commercially-available protocols, such as TCP/IP, OSI, FTP, UPnP, NFS, CIFS, AppleTalk etc. The network can be, for example, a local area network, a wide-area network, a virtual private network, the Internet, an intranet, an extranet, a public switched telephone network, an infrared network, a wireless network and any combination thereof.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include server computers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from open market.

The server farm can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared computing device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and computing media, such as but not limited to volatile and non-volatile, removable and non-removable media implemented in any method or technology for storage and/or transmission of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer-implemented method, comprising:
collecting historical usage information at a network device and/or at least one of a peer node type identification, time of day, day of a year, port identifier, switch identifier, interface packet arrival rate, interface packet drop rate or packet queue statistic that is associated with the network device, the network device being one of a plurality of network devices at a computing network;
analyzing the usage information at the network device by using one or more machine-learning algorithms;
predicting a usage pattern of the network device at a specific future time based at least upon the historical usage information;
collecting routing protocol information of the network device and one or more corresponding upstream or downstream ports; and
based at least upon predicted usage pattern or the routing protocol information, dynamically adjusting an operation state of the network device or at least one of the one or more corresponding upstream or downstream ports to achieve a power saving at the computing network.

2. The computer-implemented method of claim 1, wherein collecting historical usage information at the network device comprises collecting the historical usage information at the network device within one or more predetermined time windows, each of the one or more predetermined time windows being a fixed time period.

3. The computer-implemented method of claim 1, wherein analyzing the usage information at the network device comprises analyzing the usage information at the network device by using a linear regression model according to a Gradient descent algorithm.

4. The computer-implemented method of claim 3, further comprising:
using the linear regression model on a sampled instance of an entire feature variable set; and
adjusting a linear regression parameter to minimize an error function of the linear regression model.

5. The computer-implemented method of claim 4, further comprising:
storing the linear regression parameter in a database;
in response to a reboot, retrieving the linear regression parameter from the database; and
using the stored linear regression parameter to predict the usage pattern of the network device.

6. The computer-implemented method of claim 3, further comprising:
analyzing usage information of the plurality of network devices; and
based upon the usage information, predicting an initial usage pattern for a newly deployed network device in the computing network by using a batch-gradient descent algorithm.

7. The computer-implemented method of claim 1, wherein analyzing the usage information at the network device comprises analyzing the usage information at the network device by using a support vector machine based model according to a linear kernel algorithm.

8. The computer-implemented method of claim 1, wherein analyzing the usage information at the network device comprises analyzing the usage information at the network device by using a neural network model or support vector machine based model, the usage information at the network device including correlation between time and traffic pattern at the network device.

9. The computer-implemented method of claim 8, further comprising:
reducing a cost function at the network device by using the neural network model together with one or more forward and backward propagation algorithms.

10. The computer-implemented method of claim 8, further comprising:
analyzing, by a network controller in the computing network, usage information of the plurality of network devices by using the neural network model together with one or more backward propagation algorithms; and
forwarding a machine-learned neural network model to each of the plurality of network devices.

11. The computer-implemented method of claim 1, further comprising:
bringing up a link associated with the network device by initially advertising a high cost metric for the link; and
in response to network devices associated with the link having their forwarding entries programmed, advertising a normal cost metric for the link.

12. The computer-implemented method of claim 1, further comprising:
increasing a cost metric of a link that is to be shut down without removing any programmed forwarding entries at network devices associated with the link; and
shutting down the link after a predetermined period of time.

13. The computer-implemented method of claim 1, further comprising:
dynamically switching the network device or at least one of the one or more corresponding upstream or downstream ports to a low speed mode based at least upon the usage pattern of the network device or the routing protocol information.

14. A computer-implemented method, comprising:
randomly shuffling usage information collected from each of a plurality of network devices at a computing network;
dividing randomly shuffled usage information into two or more subsets of historical usage information;
analyzing at least one subset of the usage information of a corresponding network device by using one or more machine-learning algorithms;
predicting a usage pattern of the network device at a specific future time based at least upon the historical usage information;
collecting routing protocol information of the plurality of network devices and one or more corresponding upstream or downstream ports;
dynamically generating a reduced-power-consumption topology that scales with predicted usage pattern at the plurality of the network devices; and
dynamically adjusting an operation state of at least one of the plurality of network devices or at least one of the one or more corresponding upstream or downstream ports to achieve a power saving at the computing network.

15. The computer-implemented method of claim 14, further comprising:
repetitively analyzing at least one subset of the usage information of the corresponding network device with two or more passes until the one or more machine-learning algorithms converge.

16. The computer-implemented method of claim 15, further comprising:
randomly re-shuffling the usage information collected from the corresponding network device between the two or more passes.

17. A system, comprising:
at least one processor; and
memory including instructions that, when executed by the at least one processor, cause the system to:
collect usage information at a network device, the network device being one of a plurality of network devices at a computing network;
analyze the usage information at the network device by using one or more machine-learning algorithms;
predict a usage pattern of the network device at a specific future time based at least upon the historical usage information;
collect routing protocol information of the network device and one or more corresponding upstream or downstream ports; and
based at least upon predicted usage pattern or the routing protocol information, dynamically adjust an operation state of the network device or at least one of the one or more corresponding upstream or downstream ports to achieve a power saving at the computing network.

18. The system of claim 17, wherein the one or more machine learning algorithms include at least one of linear regression model, neural network model, support vector machine based model, Bayesian statistics, case-based reasoning, decision trees, inductive logic programming, Gaussian process regression, group method of data handling, learning automata, random forests, ensembles of classifiers, ordinal classification, or conditional random fields.

19. The system of claim 17, wherein the instructions when executed further cause the system to:
increase a cost metric of a link that is to be shut down without removing any programmed forwarding entries at network devices associated with the link; and
shut down the link after a predetermined period of time.

20. The system of claim 17, wherein the predicted usage pattern includes a predetermined buffer to take into account unexpected increases of a future traffic rate at the network device.
